(19) United States
(12) Patent Application Publication
(10) Pub. No.: US 2024/0340091 A1
(43) Pub. Date: Oct. 10, 2024

(54) ENCODER, DECODER, SYSTEMS AND METHODS FOR D-DIMENSIONAL FREQUENCY-ENCODED QUANTUM COMMUNICATION AND INFORMATION PROCESSING

(71) Applicant: Mohamed BOURENNANE, Stockholm (SE)

(72) Inventor: Mohamed BOURENNANE, Stockholm (SE)

(21) Appl. No.: 18/574,463

(22) PCT Filed: Jul. 1, 2022
(86) PCT No.: PCT/SE2022/050664

§ 371 Date: Dec. 27, 2023

(30) Foreign Application Priority Data
Jul. 1, 2021 (SE) 2150855-1

(51) Int. Cl. H04B 10/70; H04B 10/516

(52) U.S. Cl. CPC H04B 10/70; H04B 10/516

(57) ABSTRACT

The present disclosure relates to an encoder for quantum communication, the encoder comprising a first dispersive element and an encoder modulator. The first dispersive element is arranged to obtain photonic output and is configured to time delay states of a d-dimensional frequency-binned single photon comprised in said photonic output based on frequency, thereby time-binning the states of said single photon. The encoder modulator is arranged to modulate time-binned states of the single photon by modulating individual time-bins of said single photon, using a predetermined modulation scheme.

### TECHNICAL FIELD

The present disclosure relates to quantum communication and quantum information processing.

### BACKGROUND

The interdisciplinary field of quantum information processing (QIP) and quantum communication is a new and rapidly developing area of information and communication technology (ICT). It connects classical information theory with the ideas and resources of quantum theory to achieve tasks that would be impossible by classical methods alone. This fusion has led to new concepts such as the qubit [C. H. Bennett, Phys. Today October (1995) 24] and quantum teleportation [A. Zeilinger, Scientific American April (2000) 50], and new applications such as quantum cryptography [C. H. Bennett et al., Scientific American October (1992) 50]. Quantum information science and technology has also revitalized the discussion of quantum theory and created a series of exciting novel experimental tests of quantum theory [Z. Merali, Science 331 (2011) 1380].

Quantum cryptography can provide unconditional data security, as its basis is radically different from classic cryptography, the security of the information transmitted is provided by the laws of nature, such that any attempt to eavesdrop or spy on the communication may be detected [C. H. Bennett et al., Scientific American October (1992) 50]. This capability is based on the local measurement of shared, distributed entangled states, such that two communicating parties can use the perfect correlation between the outcomes of their measurements to establish a common cryptographic key. They can then ensure that there is no eavesdropper present simply by performing a Bell inequality test, since a violation of this inequality can only occur if the measured states are quantum in nature [A. K. Ekert, Phys. Rev. Lett. 67 (1991) 661; J. S. Bell, Physics 1 (1964) 195].

Various demonstrations of quantum key distribution (QKD) systems have been made over the last few years; however the security proofs of all these demonstrations still rely on a number of technical assumptions. The main assumption being that the communicating parties have full control of their local “ideal” devices and therefore there is no information leakage except for the information needed for a protocol used by the communicating parties. These assumptions are, however, very hard to justify for “real” quantum devices such as single photon sources and detectors. For example, it has been shown, that almost all available single photon detectors are vulnerable to so-called ‘hacking’ eavesdropping attacks, where an eavesdropper gains control over the detector [I. Gerhardt et al., Phys. Rev. Lett. 107 (2011) 170404].

For quantum encryption to fully guarantee security, the protocols used must be independent of the type of preparation or measurement performed and the internal workings of the devices used to make the measurement. To achieve this, a device-independent (DI) quantum communication protocol must be used, such that its security can be certified without any assumptions [A. Acín et al., Phys. Rev. Lett. 98 (2007) 230501]. In this way, communications can be secured, even if the sources and/or detectors were to be provided by a potential eavesdropper. Importantly, it has also been shown that the implementation of a secure DI quantum communication protocol is equivalent to performing a Bell inequality test between the communicating parties.

In Vienna, Boston, Geneva, Shanghai, and Tokyo research institutions and organizations are planning implementations of quantum communication channels for safe communication based on these ideas and solutions. But they are limited to proof of principle solutions, short distances, they are sensitive as well as robust against disturbance and noise. It has also been shown that some of the commercially available solutions are not secure against quantum hacker attacks [L. Lydersen, et al, Nature photonics 4, 686 (2010)]. General and strong security proofs for real implementations are missing. There are issues concerning the integration of proposed quantum solutions on existing optical networks. Some of the main technological challenges relates to communication rate, communication distance, communication system integration, tolerance to noise, and security. Therefore, today, the development of new quantum devices, implementation of novel quantum protocols, and secure communication system solutions that are resistant to noise are very interesting research and relevant and promising innovative topics.

There exists a demand for improved quantum communication and quantum information processing solutions able to address these challenges.

### SUMMARY

It is an object of the present disclosure to address one or more of the above mentioned challenges associated with quantum communication and/or quantum information processing (QIP).

It is a particular object of the present disclosure to provide a solution for increased security in quantum communication.

It is another object of the present disclosure to provide a solution for facilitating frequency encoding in QIP, quantum communication and/or quantum cryptography.

It is yet another object of the present disclosure to reduce the cost and complexity of systems supporting frequency encoding in QIP, quantum communication and/or quantum cryptography.

According to a first aspect of the present disclosure, there is provided an encoder for quantum communication. The encoder comprising a first dispersive element and an encoder modulator. The first dispersive element is arranged to obtain photonic output and is configured to time delay states of a d-dimensional frequency-binned single photon comprised in said photonic output based on frequency, thereby time-binning the states of said single photon. The encoder modulator is arranged to modulate time-binned states of the single photon by modulating individual time-bins of said single photon, using a predetermined modulation scheme.

This has the advantage of increasing the difficulty of eavesdropping the quantum communication. This further has the advantage of allowing transmission of quantum information prepared in high-dimensional frequency-binned single photons, such as a qudit, with a low number of detectors.

In some examples, the encoder comprises a second dispersive element arranged after the encoder modulator, and configured to time delay the states of said single photon based on frequency to reduce a temporal separation of the states of said single photon. In some of these examples the second dispersive element is configured to time delay the states of said modulated single photon based on frequency to substantially reduce the temporal separation of at least two time-binned states to zero.

In some examples of the encoder, the second dispersive element is configured to time delay the modulated states of the single photon such that modulated time-binned states of the single photon have substantially the same spatiotemporal propagation after interaction with the second dispersive element.

This has the advantage of allowing the time-binned states of the single photon exiting the encoder modulator to be more spatiotemporally gathered than during modulation, whereby eavesdropping may be made more difficult.

In some examples, the encoder further comprises a photon source arranged to provide the photonic output comprising the d-dimensional frequency-binned single photon.

In some examples, the photon source is arranged to provide said single photon in a frequency comb state.

This has the advantage of providing a high-dimensional frequency-binned single photon with a plurality of states with different distinguishable frequencies as input to the encoder dispersive element. This, in turn, has the advantage of facilitating preparation of qudits by the encoder, using the principles described above.

According to a second aspect of the present disclosure, there is provided a decoder for quantum communication. The decoder comprises a decoder dispersive element, a decoder modulator, and a photon detector. The decoder is arranged to receive photonic output comprising a d-dimensional frequency-binned single photon via a quantum channel. The decoder dispersive element is arranged to time-bin states of the received single photon by time delaying the states of the received single photon based on frequency. The decoder modulator is arranged to modulate time-binned states of the single photon by modulating individual time-bins of said single photon using a predetermined modulation scheme. The photon detector is arranged to detect the single photon and determine the time-bin it was detected in.

This has the advantage of allowing detection of received quantum information prepared in high-dimensional frequency-binned states of single photons, where the states are spatiotemporally overlapping.

According to a third aspect of the present disclosure, there is provided a system for single photon quantum communication. The system comprises the encoder of the first embodiment and the decoder of the second embodiment. The encoder and the decoder are arranged to communicate with d-dimensional frequency-binned single photons via the quantum communication channel. The decoder modulator and the encoder modulator are arranged to modulate the states of the single photon utilizing the same predetermined modulation scheme.

This has the advantage of allowing quantum communication over a quantum channel utilizing high-dimensional frequency-binned single photons and utilizing a plurality of frequency-binned states. This further has the advantage of allowing for high-dimensional frequency-encoded quantum key distribution protocols.

According to a fourth aspect of the present disclosure, there is provided a system for entangled photon pair quantum communication. The system comprising an entangled photon pair source, and two decoders according to the second aspect of the present disclosure. The entangled photon pair source is arranged to transmit to each decoder via a respective quantum channel photonic output comprising one photon of one pair of entangled photons, wherein said entangled photons are a d-dimensional frequency-bin entangled photon pair. The decoder modulator of each decoder is configured to modulate the states of the received photon utilizing the same predetermined modulation scheme.

This has the advantage of allowing quantum key distribution utilizing entangled pairs of high-dimensional frequency-binned single photons.

According to a fifth aspect of the present disclosure, there is provided a method for single photon quantum communication. The method comprising
obtaining a photonic output from a photon source, the photonic output comprising a d-dimensional frequency-binned single photon in a superposition of states with different frequencies;
time-binning the states of the single photon by time-delaying the states of the single photon using a first frequency dispersion;
modulating the time-binned states of the single photon by modulating individual time-bins of said single photon, using a predetermined modulation scheme; and
transmitting the modulated single photon via a quantum channel.

According to a sixth aspect of the present disclosure, there is provided a method for single photon quantum communication, the method comprising
receiving a photonic output via a quantum channel, wherein said photonic output comprises a d-dimensional frequency-binned single photon in a superposition of states with different frequencies;
time-binning the received single photon by time delaying the states of said single photon using a first receiver frequency dispersion;
modulating the states of the single photon by modulating individual time-bins of said single photon, using a predetermined modulation scheme; and
detecting the single photon and determining the time-bin the single photon was detected in.

According to a seventh aspect of the present disclosure, there is provided a method for entangled photon pair quantum communication. The method comprises
transmitting two photonic outputs, each via a respective quantum channel, wherein each photonic output comprises one photon of one pair of entangled photons, wherein said entangled photons are a d-dimensional frequency-bin entangled photon pair, and wherein each photon is in a superposition of states with different frequencies;
receiving, in two decoders, one photon each of the pair of entangled photons, and, in each of the decoders:
time-binning the states of the received photon using frequency dispersion to time-bin the states of the received photon;
modulating the time-binned states of the photon by modulating individual time-bins of said photon, using a predetermined modulation scheme; and
detecting the photon and determining the time-bin said photon was detected in.

According to a eighth aspect of the present disclosure, there is provided a computer program product comprising a non-transitory computer-readable storage medium having thereon a computer program comprising program instructions. The computer program being loadable into a processor and configured to cause the processor to perform the method according to the fifth, sixth and/or seventh aspect of the present disclosure.

The computer program corresponds to the steps performed by the method discussed above.

### BRIEF DESCRIPTION OF THE DRAWINGS

FIG. 1a-c shows schematically a system comprising an encoder and a decoder for quantum communication with d-dimensional frequency-binned single photons.

FIG. 2 schematically illustrates quantum states of a d-dimensional frequency-binned single photon inside an encoder.

FIG. 3 shows schematically a system for entangled photon pair quantum communication utilizing d-dimensional frequency-bin entangled photon pairs.

FIG. 4 depicts schematically a method for quantum communication utilizing a d-dimensional frequency-binned single photon.

FIG. 5 depicts schematically a method for entangled photon pair quantum communication utilizing d-dimensional frequency-bin entangled photon pairs.

FIG. 6 depicts schematically a data processing unit comprising a computer program product.

FIG. 7a-b shows schematically a decoder for quantum communication with d-dimensional frequency-binned single photons utilizing interference.

FIG. 8 illustrates a decoder method for quantum communication with d-dimensional frequency-binned single photons utilizing interference.

FIG. 9 illustrates phase modulation in the frequency domain for three frequency-binned states of a single photon.

FIG. 10 schematically illustrates a frequency shifter comprising a dispersive element and a photon state passing through said frequency shifter.

### DETAILED DESCRIPTION

Throughout the figures, same reference numerals refer to same parts, concepts, and/or elements. Consequently, what will be said regarding a reference numeral in one figure applies equally well to the same reference numeral in other figures unless not explicitly stated otherwise. A description of terms is listed at the end of the detailed description.

Some standard supporting equipment for quantum communication, such as means for synchronization between encoder and decoder, or reference lasers are typically not described in the examples or shown in the figures. The operation and internal communication between any computers or control circuitry controlling the active components of the encoder or decoder is typically not shown or described. Detailed descriptions of such standard supporting equipment for quantum communication is beyond the purview of this document.

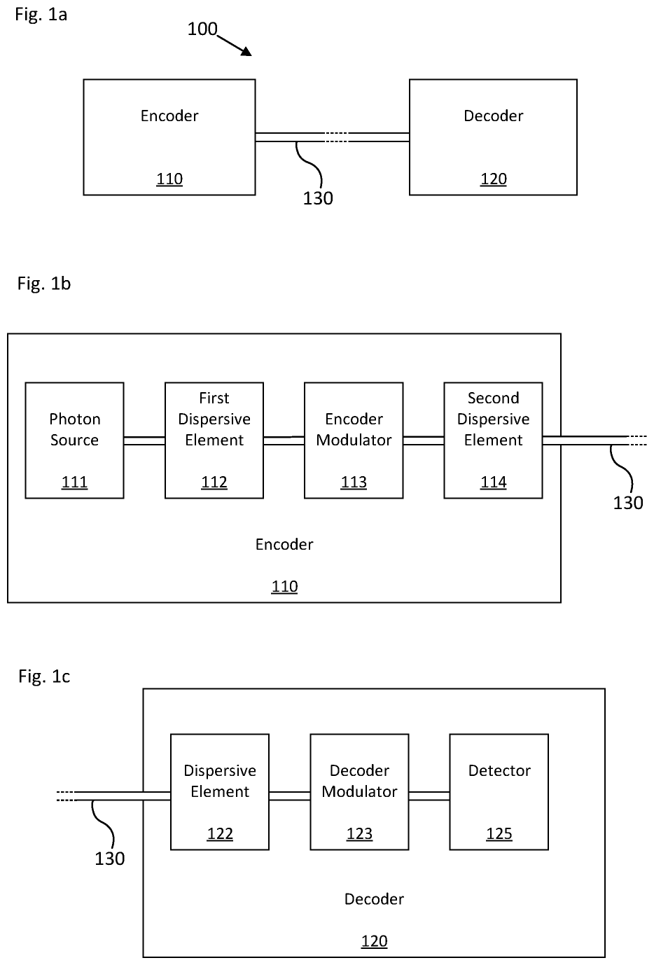

FIG. 1a-c shows schematically a system 100 comprising an encoder 110 and a decoder 120 for single photon quantum communication via a quantum channel 130. The system 110 is arranged to communicate utilizing d-dimensional frequency-binned single photons.

In the description relating to FIG. 1a-c the examples of the encoder 110 or the decoder 120 as such are to be understood as both examples of the encoder 110 and/or the decoder 120 comprised in the system 100, and examples of the encoder 110 or the decoder 120 as individual devices.

FIG. 1a shows the example system 100 with the encoder 110 and the decoder 120 being arranged to communicate via a quantum channel 130. In this example system 100 the quantum channel 130 is an optical fibre. In some examples the quantum channel 130 is a free-space quantum channel. The encoder 110 is arranged to provide a single photon in a d-dimensional frequency-bin entangled state, actively modulate each frequency-bin of said single photon and transmit said modulated single photon. The decoder 120 is arranged to receive, and actively modulate each frequency-bin of said single photon and detect said single photon in a corresponding time-bin. The type of modulation of the decoder 120 corresponds to the type of modulation of the encoder 110.

The dimensionality of the d-dimensional frequency-binned single photon is at least two. In some of these examples the dimensionality is at least three, at least five, at least eight, at least twenty, at least fifty, at least two hundred, or at least one thousand.

FIG. 1b shows the example encoder 110 comprising a photon source 111, a first dispersive element 112, an encoder modulator 113, and a second dispersive element 114. The photon source 111 is arranged to provide a photonic output comprising a d-dimensional frequency-binned single photon, such as a photon in a superposition of at least two states with different frequencies that are distinguishable. In this example the provided single photon is in a single photon frequency comb state. The term single photon frequency comb state relates to a single photon state that is a superposition of a plurality of states with different frequency that may be represented in the frequency domain by narrow lines that are clearly separated. In this example the photon source 111 is arranged to provide the single photon in a single photon frequency comb state wherein the superimposed plurality of states have substantially the same spatiotemporal propagation, such that a photon detector would detect the provided single photon at substantially the same time irrespective of the state (frequency) of the detected single photon. The first dispersive element 112 is arranged to time delay each of the superimposed plurality of states of the provided single photon based on frequency utilizing dispersion, thereby time-binning the superimposed plurality of states of the single photon.

In the example in FIG. 1b the encoder modulator 113 is arranged to modulate the time-binned states of the single photon by modulating the corresponding time-bins utilizing a predetermined modulation scheme. In some examples the encoder modulator 113 is an electro optic modulator. In some examples the encoder modulator 113 is a phase modulator arranged to encode information in the relative phase of states. In some examples the encoder modulator 113 utilizes phase modulation, amplitude modulation, IQ modulation, coherent modulation, quadrature amplitude modulation, and/or polarization modulation. The encoder modulator 113 comprises and/or is in communication with a random number generator (not shown), and modulates the time-binned states of the single photon based on random values obtained form said random number generator. The random number generator may be a quantum random number generator utilizes quantum physics to generate random numbers.

It is to be understood that the expression “predetermined modulation scheme” relates to the modulation scheme as such being predetermined, which does not rule out that the modulation itself is random. For example the predetermined modulation scheme may comprise utilizing random number generators to randomly select the basis used, such as randomly selecting rectilinear basis or diagonal basis in the BB84 protocol.

In the example in FIG. 1b the second dispersive element 114 is arranged to time delay each of the superimposed plurality of states of the modulated single photon based on frequency. In this example the second dispersive element 114 is configured to time delay the plurality of states of the single photon such that said states have substantially the same spatiotemporal propagation. In this example the sum of the total time delay caused by the first dispersive element 112 and the second dispersive element 114 is substantially the same for each of the superimposed plurality of states, such that the spatiotemporal propagation relationship between states upon entering the first dispersive element 112 is similar to the relationship upon exiting the second dispersive element 114. In this example the encoder 110 is arranged to transmit the modulated single photon exiting the second dispersive element 114 to the decoder 120 via the quantum channel 130.

In some examples the first dispersive element 112 has positive group velocity dispersion, and the second dispersive element 114 has negative group velocity dispersion. In some examples the first dispersive element 112 has negative group velocity dispersion, and the second dispersive element 114 has positive group velocity dispersion. Positive group velocity dispersion corresponds to longer wavelength components travelling faster than the shorter wavelengths through a material, thus time delay is longer for lower frequencies. Negative group velocity dispersion corresponds to longer wavelength components travelling slower than the shorter wavelengths through a material.

In some examples the encoder 110 comprises the encoder modulator 113 and the first dispersive element 112 arranged before the encoder modulator 113, and the second dispersive element 114 arranged after the encoder modulator 113. In some of these examples the encoder 110 is arranged to time-bin the provided d-dimensional frequency-binned single photon utilizing the first dispersive element 112, thereafter actively modulate said time-binned states of the single photon utilizing the encoder modulator 113 in the corresponding time-bins, and thereafter time delay the states of said single photon based on frequency utilize the second dispersive element 114 such that said states have substantially the same spatiotemporal propagation upon transmission. The term “after” and “before” are to be understood as downstream and upstream respectively in relation to the movement of photons through the encoder 110.

In some examples the encoder 110 is arranged to, in order,
provide a d-dimensional frequency-binned single photon with the photon source 111, wherein at least two states of the single photon have substantially the same spatiotemporal propagation;
time delay each of the states of the provided single photon based on frequency utilizing the first dispersive element 112, thereby time-binning the states of the single photon into time-bins;
for each time-bin, actively modulate the corresponding time-binned state of the single photon with the encoder modulator 113; and
time delay each of the states of the modulated single photon based on frequency utilizing the first dispersive element 114, wherein the time delay of the first 112 and second dispersive element 114 is configured to time delay the at least two states to have substantially the same spatiotemporal propagation.

In some examples the encoder 110 does not comprise the photon source 111, wherein the encoder 110 is configured to obtain the photonic output comprising the single photon in a superposition of at least two states with different distinguishable frequencies.

In some examples the encoder 110 comprises the encoder modulator 113 and the first dispersive element 112 arranged before the encoder modulator 113 and/or the second dispersive element 114 arranged after the encoder modulator 113.

In some examples the encoder 110 comprises the encoder modulator 113 and the first dispersive element 112 arranged before the encoder modulator 113. In some of these examples the encoder 110 is arranged to time-bin the obtained d-dimensional frequency-binned single photon utilizing the first dispersive element 112, and thereafter actively modulate said time-binned states of the single photon utilizing the encoder modulator 113 in the corresponding time-bins.

In some examples the encoder 110 comprises the encoder modulator 113 and the second dispersive element 114 arranged after the encoder modulator 113. In some of these examples the encoder 110 is arranged to actively modulate the obtained time-binned d-dimensional frequency-binned single photon utilizing the encoder modulator 113 in the corresponding time-bins, and thereafter utilize the second dispersive element 114 to time delay the states of said photon based on frequency such that at least two of said states have substantially the same spatiotemporal propagation.

In some examples the photon source 111 comprises a true single photon source.

In some examples the photon source 111 comprises a heralded single photon source.

In some examples the photon source 111 comprises a component utilizing weak coherent light to provide single photons.

In some examples the photon source 111 comprises an optical cavity, a micro resonator, a spontaneous four wave mixing (SFWM) component, and/or a nonlinear resonator, such as resonators utilizing spontaneous parametric down conversion (SPDC).

In some examples the photon source 111 is arranged to provide the single photon in the single photon frequency comb state. In some examples the photon source 111 is arranged to utilize supercontinuum generation and/or Kerr frequency comb generation to provide the single photon in the single photon frequency comb state. In some of these examples the single photon in the single photon frequency comb state has frequencies in a broad range that are substantially equidistant narrow lines in the frequency domain.

In some example the photon source 111 further comprises drivers and/or control circuitry (not shown) arranged to control the photon source 111.

In some example the encoder modulator 113 further comprises drivers and/or control circuitry (not shown) arranged to control the encoder modulator 113.

In some examples the first dispersive element 112 is comprised in the photon source 111, wherein the photon source 111 is arranged to provide the photonic output comprising the d-dimensional frequency-binned single photon and wherein at least two states of said provided photon are time-binned based on frequency.

In some examples the first dispersive element 112 and/or the second dispersive element 114 comprises a Fibre-Bragg grating (FBG), a free space diffraction grating, and/or an other dispersive device. The role of the dispersive element is to time-bin the states of the single photon based on the frequency-bins of the states of the single photon.

In some examples the first dispersive element 112 is arranged to time delay each of the superimposed plurality of states of the provide single photon, wherein the single photon is in a single photon frequency comb state and states of the single photon have substantially the same spatiotemporal propagation, and wherein the resulting time-binned states of the single photon is time-binned such that the encoder modulator 113 may be able to modulate in each time-bin individually.

In some examples the first dispersive element 112 is arranged to obtain time-binned states of single photons and time delay each of the superimposed plurality of states of the obtained time-binned states of the single photon based on frequency, wherein at least two states of said single photon are time-binned, thereby altering the time-binning of the single photon. In some of these examples the time-binned states of the obtained single photon have a time-bin frame distribution based on frequency that differs from a suitable time-binning for the encoder modulator 113 and/or the second dispersive element 114, such as too large and/or too small temporal separation between at least some states of said obtained single photon. In some of these examples the temporal separation between at least two states is too large and the first dispersive element 112 is arranged to time delay the obtained time-binned states of the single photon such as to decrease the temporal separation between said at least two states resulting in a time-bin frame distribution more suitable for the encoder modulator 113 and/or the second dispersive element 114.

In some example the encoder modulator 113 is arranged to modulate all d states of the time-binned d-dimensional frequency-binned single photon by individually modulating each time-bin corresponding to said single photon.

In some examples the second dispersive element 114 is configured to time delay the states of said modulated time-binned d-dimensional frequency-binned single photon based on frequency to reduce a temporal separation of all d time-binned states. In some of these examples all d time-binned states have substantially the same spatiotemporal propagation exiting the second dispersive element 114. In some examples the second dispersive element 114 is configured to time delay the states of said modulated time-binned d-dimensional frequency-binned single photon based on frequency to substantially reduce the temporal separation of at least two time-binned states to zero.

In some examples the second dispersive element 114 is arranged to alter the time-binning of the states of the modulated single photon. In situations where eavesdropping is not an issue it may not be of interest to make the states of the transmitted modulated single photon have substantially the same spatiotemporal propagation, instead the second dispersive element 114 may be configured to alter the time-binning for the receiver of the transmitted modulated single photon. In some examples, wherein the modulated single photon exiting the encoder modulator 113 is suitable for transmission, the second dispersive element 114 may be omitted.

When using the encoder 110 it may typically be the case that the spatiotemporal grouping or time-binning of states of an obtained d-dimensional frequency-binned single photon is well known in advance, and the encoder 110 may be specifically designed around said known time-binning and/or frequency-binning of states. In some of these cases the encoder 110 is arranged to obtain single photons in substantially the same state or comprise a photon source 111 configured to provide single photons in substantially the same state, such as photons having the same frequency-binning and time-binning of states.

FIG. 1c shows the example decoder 120 comprising a decoder dispersive element 122, a decoder modulator 122 and a photon detector 125. The decoder 120 is arranged to receive photonic output comprising a d-dimensional frequency-binned single photon via the quantum channel 130. The decoder dispersive element 122 is arranged to time-bin the received single photon by time delaying each of the superimposed plurality of states of the received single photon based on frequency. In this example the time-bins associated with the states of the single photon exiting the decoder dispersive element 122 corresponds to the time-bins associated with the states of the single photon exiting the first dispersive element 112. The decoder modulator 123 is arranged to modulate the plurality of states of the single photon by the modulating the received time-binned states of the single photon for each time-bin individually, using a predetermined modulation scheme. The photon detector 125 is arranged to detect the modulated single photon and determine the time-bin it was detected in.

In some examples the decoder 120 is arranged to receive a single photon with states having substantially the same spatiotemporal propagation, and the decoder dispersive element 122 is a positive dispersive element or a negative dispersive element arranged to time-bin said states.

In some examples the decoder 120 is arranged to receive a d-dimensional frequency-binned single photon, wherein a plurality of states of said single photon have substantially the same spatiotemporal propagation. In some of these examples the decoder 120 is arranged to receive single photons with all photon states having substantially the same spatiotemporal propagation.

In some examples the decoder 120, the decoder 120 is configured to receive single photon that have undergone non-local dispersion while travelling to the decoder 120 through the quantum channel 130, wherein the decoder dispersive element 122 is further configured to provide non-local dispersion cancellation. In some of these examples the received single photon after non-local dispersion in the quantum channel 130 is time-binned in a manner suitable for the decoder modulator 123, whereby the decoder dispersive element 122 may be omitted.

The dimensionality of the received d-dimensional frequency-binned single photon is at least two. In some of these examples the dimensionality is at least three, at least five, at least eight, at least twenty, at least fifty, at least two hundred, or at least one thousand.

In some examples the photon detector 125 comprises an avalanche photodiode and/or a nanowire superconducting photon detector, and/or any other single photon detector. In some examples the photon detector 125 comprises means for single-photon interference.

The predetermined modulation scheme may comprise at least two basis corresponding to the encoder preparing the transmitted single photon and the decoder measuring the single photon. In some examples the system 100, the encoder 110 and/or the decoder 120 utilizes phase modulation, amplitude modulation, quadrature amplitude modulation, coherence modulation and/or polarization modulation. In some examples the encoder modulator 113 and/or the decoder modulator 123 comprises an optical in-phase and quadrature (IQ) modulator.

In the example system 100 in FIG. 1a-c the second dispersive element 114 in the encoder 110 temporally gathers the superimposed plurality of states of the single photon together before the single photon wave packet is transmitted into the quantum channel 130, thereby making eavesdropping more difficult to perform and/or harder to perform undetected. In this example the plurality of states of the single photon provided by the photon source 111 are temporally gathered, and the decoder dispersive element 122 effectively cancels out the relative time delay between the plurality of states of the single photon introduced by the second dispersive element 114. In some examples the decoder dispersive element 122 time delays the single photon with substantially the same frequency dependence as the second dispersive element 114, whereby states may become time-binned in opposite order of the time-bins in the encoder modulator 113.

In some examples the system 100 comprises the encoder 110 comprising the photon source 111, the first dispersive element 112, and the encoder modulator 113; and the decoder 120 comprising the decoder modulator 122 and the photon detector 125. The encoder 110 and the decoder 120 being arranged to communicate via the quantum channel 130. The second dispersive element 114 and/or the decoder dispersive element 122 may be omitted in applications where eavesdropping is not a significant risk, such as communication between parts in a quantum computer.

The encoder 110 and/or decoder 120 may comprise computer control devices (CPU, GPU, ASIC, FPHA, MCU, PLD CPLD, RAM, ROM. Flash, Hard drive, optical desk).

In some examples the encoder 110 and/or decoder 120 may be configured for single photons in the frequency range 1 GHz to 2 GHz, 4 GHz to 8 GHZ, 200 MHz to 20 GHZ, and/or 3 MHz to 300 GHz.

The encoder 110 and/or the decoder 120 may be comprised in a secure quantum communication network, a quantum computer, a quantum information processor, a quantum random number generator, a quantum sensing arrangement, and/or a quantum metrology arrangement. In some of these examples the encoder 110 and/or the decoder 120 may be arranged as input and/or readout quantum gates in a quantum computer.

In some examples the encoder 110 and/or the decoder 120 are arranged to provide and/or store values indicative of the modulation performed on time-bins.

In some examples, the encoder 110 and/or the decoder 120 comprise a frequency shifter comprising, in order, a frequency modulator, the dispersive element 112,122, and an amplitude modulator, wherein the frequency shifter is arranged to
receive a photon state at a first frequency,
split the photon state into a plurality of frequencies utilizing the frequency modulator,
time-bin said plurality of frequencies utilizing the dispersive element 112,122, and
amplitude modulate said time-binned plurality of frequencies to only output one of said plurality of frequencies utilizing the amplitude modulator.

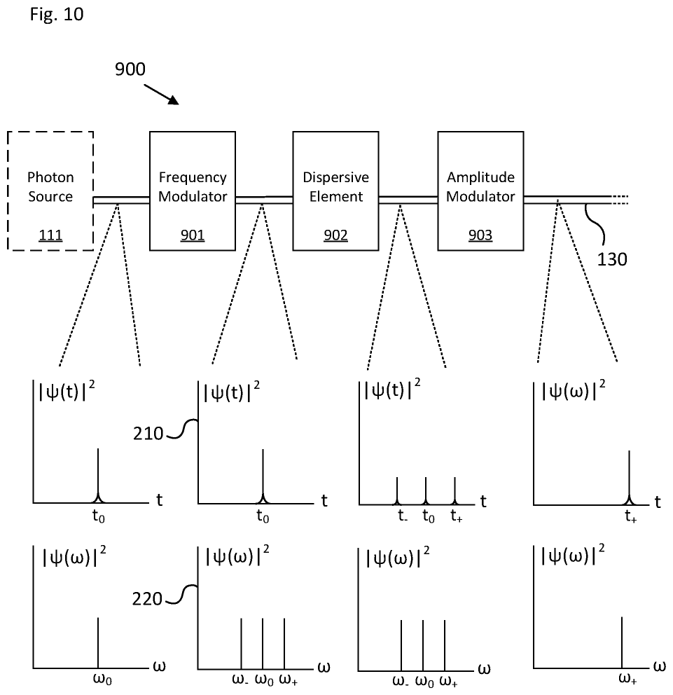

The encoder 110 and/or the decoder 120 may comprise a frequency shifter 900 according to the description of FIG. 10.

The frequency shifter may be used in a quantum communication protocol to provide a randomly selected basis and/or information encoding.

In some examples the system 100 comprises a plurality of decoders 120, and further comprises a frequency router (not shown) arranged to transmit to each state of said single photon to one of the plurality of decoders 120 via quantum channels. In some of these examples the frequency router is arranged to transmit to each of the plurality of decoders 120 a true subset of the states of the single photon. It is to be understood that being arranged to transmit a true subset of the states of the single photon corresponds to transmitting at least a range of frequencies corresponding to one of the time-bins of said single photon. The frequency router allows one encoder 110 to send single photon states to a plurality of decoders 120. In some examples the plurality of decoders 120 collocated and the frequency router may be located at the plurality of decoders 120. In some examples the frequency router is arranged at a location between the encoder 110 and the decoder 120.

In some examples, the system 100 comprises one or more frequency shifters 900 according to the description of FIG. 10.

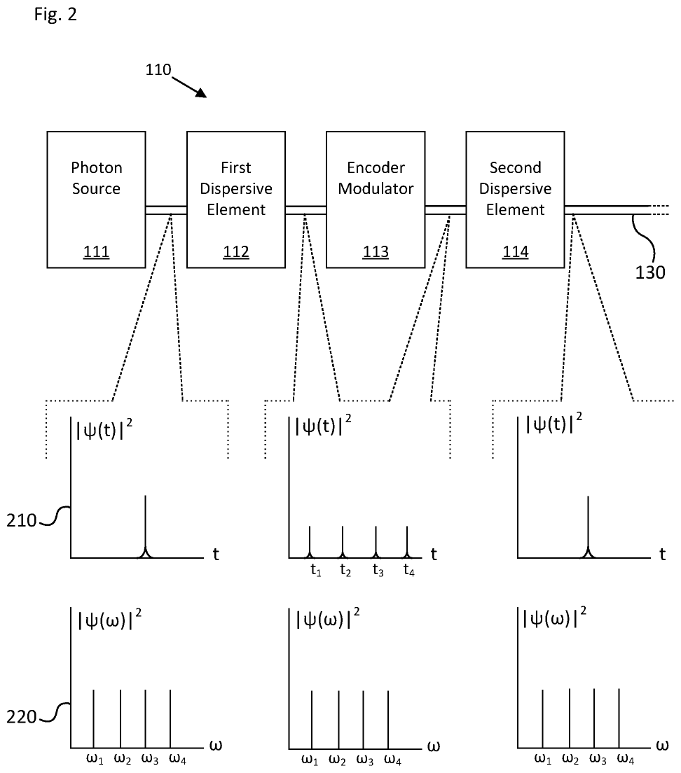

FIG. 2 schematically illustrates single photon wave packet states inside an encoder 110. The illustrated example shows a single photon provided by a photon source 111 in the time-domain 210 and the frequency-domain 220 as it propagates through the encoder 110 to a quantum channel 130. The encoder 110 may be the encoder 110 described in FIG. 1b. The representation of the single photon in the time-domain 210 and the frequency-domain 220 serve the purpose to illustrate temporally separating and temporally gathering states of the single photon based on frequency, and may not accurately depict an obtained experimental measurement.

The single photon provide by the photon source 111 is in a superposition of a plurality of states with different distinguishable frequencies. In this example, states with four different frequencies ω₁, ω₂, ω₃, ω₄ are represented in the depicted frequency-domain 220. In this example the plurality of states of the single photon provide by the photon source 111 have substantially the same spatiotemporal propagation, and thus are overlapping in the time-domain 210.

After passing through a first dispersive element 112 the states of the single photon have been time delayed based on frequency, whereby the four states are temporally separated. In this example the states with four different frequencies are separated correspond to the times t₁, t₂, t₃, t₄ as represented in the corresponding time-domain 220. The first dispersive element 112 causes the frequency-binning of the initially temporally gathered states to result in a time-binning of said states. In this example the first dispersive element 112 is a negative dispersive element.

The single photon with temporally separated states enters an encoder modulator 113, wherein the encoder modulator 113 is arranged to modulate states corresponding to different times t₁, t₂, t₃, t₄ individually utilizing a predetermined modulation scheme. In this example the modulation does not introduce a substantial relative time delay between states, or introduce a substantial relative change in the relative frequency between states, such that the single photon representations in the time-domain 210 and the frequency-domain 220 are substantially the same upon entering and exiting the encoder modulator 113.

After passing through a second dispersive element 114 the states of the single photon have been time delayed based on frequency in an inverse frequency dependence to the first dispersive element 112, whereby the states are temporally gathered. In this example the states with four different frequencies have substantially the same spatiotemporal propagation after the second dispersive element 114, and are thus once again overlapping in the time-domain 210. In this example the sum of the time delay through the first 112 and the second dispersive element 114 was substantially the same for each state of the single photon, whereby the time-binning is substantially the same for the states of the single photon exiting the second dispersive element 114 as the states of the single photon entering the first dispersive element 112. In this example the second dispersive element 114 is a positive dispersive element.

In this example a decoder (not shown) arranged at the other end of the quantum channel 130 may be configured temporally separate the single photon in a manner similar to the first dispersive element 112 (negative dispersive), and then the decoder may modulate and detect the single photon in one of the temporally separated states. In an alternative example the decoded may be configured temporally separate the single photon in a manner similar to the second dispersive element 114 (positive dispersive), thereby time-binning the states in opposite order (t₄, t₃, t₂, t₁) based on frequency.

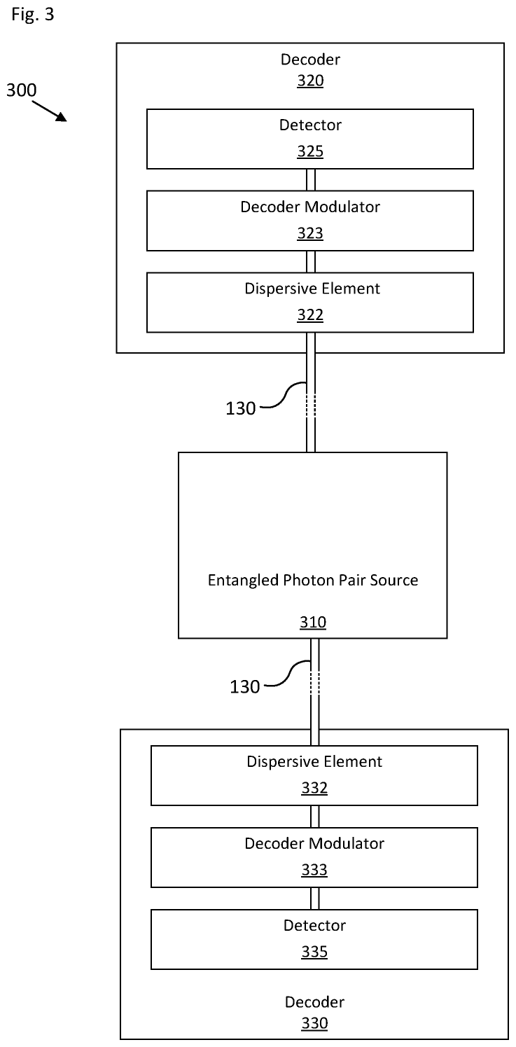

FIG. 3 shows schematically a system for entangled photon pair quantum communication. The system comprises an entangled photon pair source 310, and two decoders 320,330. Each of the two decoders 320,330 may be the decoder 120 according to the description of FIG. 1c.

The entangled photon pair source 310 is arranged to transmit to each decoder 320,330 via quantum channel 130 photonic output comprising one photon of a pair of entangled photons, wherein each photon is in one of at least two states with different distinguishable frequencies. The transmitted entangled photon pair are correlated in frequency.

In some examples each photon is a d-dimensional frequency-binned photon. As two photons of a pair of entangled photons are correlated the term “single photon” is not used to describe such photons in the system 300 for entangled photon pair quantum communication, however, from the perspective of the decoders 320,330 each photon may correspond to the “single photon” used in single photon system (100) described in FIG. 1a.

Each decoder 320,330 comprises a decoder dispersive element 322, a decoder modulator 323, and a photon detector 325. Each decoder 320,330 is arranged to receive photonic output comprising a photon in a superposition of at least two states with different distinguishable frequencies via the quantum channel 130. Each decoder dispersive element 322,332 is arranged to alter the temporal separation of photon states by time delaying the received photon using frequency dispersion to time-bin the at least two states. Each decoder modulator 323,333 is arranged to modulate the at least two states of the photon by modulating the received time-binned states of the photon for each time-bin individually, using a predetermined modulation scheme. Each photon detector 325,335 is arranged to detect the photon and determine the time-bin it was detected in.

In some examples at least one photon detector 325,335 comprises means for photon interference.

In some examples at least one decoder 320,330 is configured to receive photons that have undergone non-local dispersion while travelling to the decoder 320,330 through the quantum channel 130, wherein the decoder dispersive element 322,332 is further configured to provide non-local dispersion cancellation. In some of these examples the received photon after non-local dispersion in the quantum channel 130 is time-binned in a manner suitable for the decoder modulator 323,333, whereby the decoder dispersive element 322,332 may be omitted.

Photons traveling in the quantum channel 130, such as an optical fibre, may be affect by non-local dispersion. The entangled photon pairs are correlated in frequency. In some examples only one element is required to perform non-local dispersion cancellation to cancel the dispersion of the entangled photon pair due to travelling through the respective quantum channel 130.

In some examples the system 300 comprises for each photon of said photon pair a plurality of decoders 320,330, and the system 300 further comprises at least one frequency router (not shown) arranged to for each photon transmit each state of said photon to one of said corresponding plurality of decoders 320,330 via quantum channels. In some of these examples the frequency router is arranged to for each photon transmit to each of the corresponding plurality of decoders 320,330 a true subset of the states of the single photon. It is to be understood that being arranged to transmit a true subset of the states of the single photon corresponds to transmitting at least a range of frequencies corresponding to one of the time-bins of said single photon. In some examples the frequency router is located at the plurality of decoders 320,330, and/or at between the entangled photon pair source 310 and the plurality of decoders 320,330.

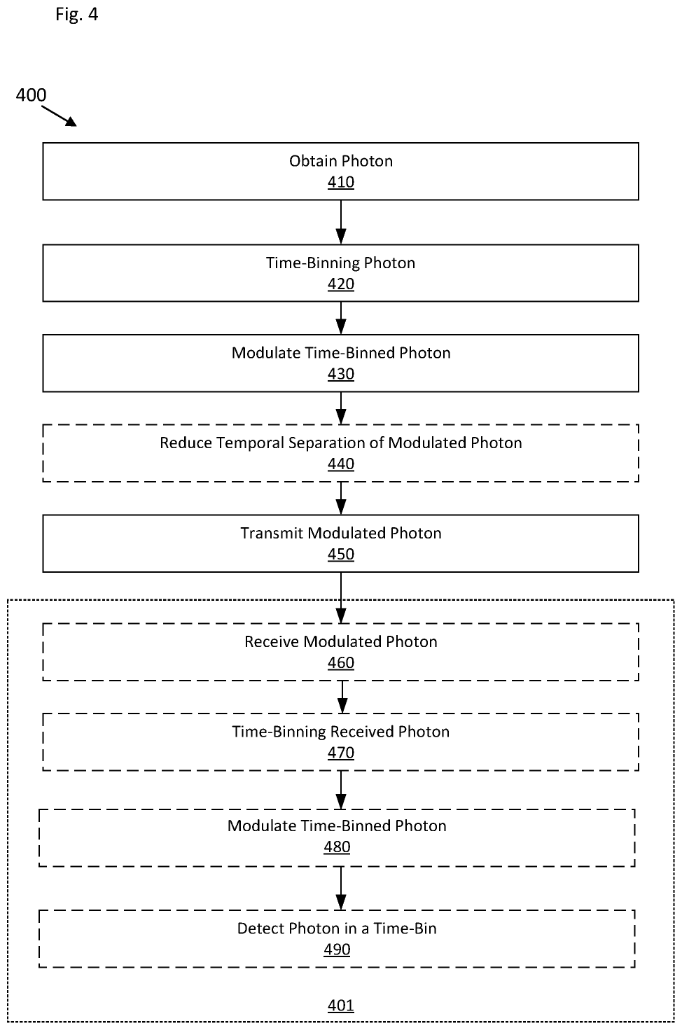

FIG. 4 depicts schematically a method for single photon quantum communication. The example method 400 comprises
obtaining 410 a d-dimensional frequency-binned single photon in a superposition of at least two states with different frequencies,
time-binning 420 each single photon state based on frequency using a first frequency dispersion, thereafter the at least two states of the single photon correspond to different time-bins,
modulating 430 the at least two states of the single photon corresponding to different time-bins based on time-bin utilizing on a predetermined modulation scheme, and
transmitting 450 the modulated single photon via a quantum channel.

In some example the method 400 further comprises
receiving 460 the transmitted single photon via the quantum channel,
modulating 480 the at least two states of the single photon corresponding to different time-bins based on time-bin utilizing the predetermined modulation scheme,
detecting 490 the single photon and determining the time-bin the single photon was detected in, thereby determining the state of the detected single photon.

In some examples the method further comprises determining the performed modulation of the detected state based on the determined time-bin that said single photon was detected in. In some examples of the method 400, detecting 490 further comprises performing single-photon interference of said single photon.

In some examples of the method 400, transmitting 450 further comprises transmitting each photon states to one of a plurality of receivers, and wherein receiving 460 the transmitted single photon comprises receiving said states of the single photon at said corresponding receivers. Dividing the transmitted single photon allows for one sender to provide several receivers with single photon states.

In some of examples the method 400, after modulating 430, further comprises reducing 440 the temporal separation of time-binned states of the single photon introduced by time-binning 420 each single photon state based on frequency using a second frequency dispersion. In some of these examples the method further comprises, after receiving 460 the single photon, time-binning 470 said received single photon using a first receiver frequency dispersion, thereafter the at least two states of said single photon correspond to different time-bins. In some examples reducing 440 the temporal separation of time-binned states of the single photon comprises substantially cancelling the time-binning 420, such that modulated time-binned states of the single photon have substantially the same spatiotemporal propagation after reducing 440 the temporal separation using the second frequency dispersion.

The first frequency dispersion, the second frequency dispersion and the first receiver frequency dispersion are the terms used for the frequency dispersions using to time-bin 420 each single photon state, reduce 440 the temporal separation of time-binned states of the single photon, and time-bin 470 said received single photon based on frequency respectively.

In some examples the obtained single photon is in a superposition of at least three states with different frequency. In some of these examples the number of states with different frequency is at least five, at least eight, at least twenty, at least fifty, at least two hundred, or at least one thousand.

In some examples the obtained single photon in a superposition of at least two states with different frequency is a d-dimensional frequency-binned single photon.

In some examples modulating 430,480 the time-binned states of the single photon is performed according to the predetermined modulation scheme. In some of these examples modulating 430,480 is at least partially performed randomly.

FIG. 4 further depicts a method for single photon quantum communication, the method 401 comprising
receiving 460 a photonic output via a quantum channel, wherein said photonic output comprising a d-dimensional frequency-binned single photon in a superposition of at least two states with different frequencies;
time-binning 470 said states of the single photon by time delaying the received single photon using a first receiver frequency dispersion to time-bin the at least two states of said single photon;
modulating 480 the time-binned at least two states of the single photon by individually modulating each time-bin associated with the time-binned states of the single photon, using a predetermined modulation scheme; and
detecting 490 the modulated time-binned states of the single photon and determining the time-bin said single photon was detected in.

In some examples modulating 480 the time-binned states of the single photon is performed according to the predetermined modulation scheme.

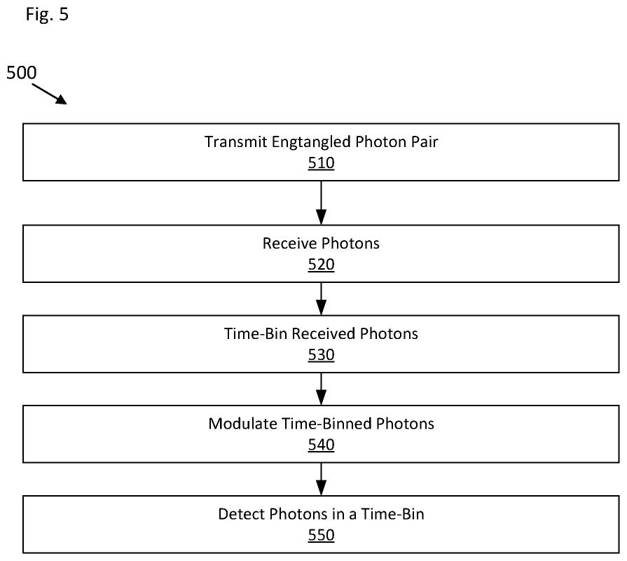

In some examples the method further comprises determining the performed modulation of the detected state based on the determined time-bin said single photon was detected in. FIG. 5 depicts schematically a method for entangled photon pair quantum communication. The method 500 comprises
transmitting 510 two photonic outputs via two quantum channels 130, wherein each photonic output comprises one photon of one pair of entangled photons, wherein said entangled photons are a d-dimensional frequency-bin entangled photon pair, and wherein each photon is in a superposition of at least two states with different frequency,
receiving 520 the photonic output transmitted via each quantum channel 130;
increasing 530 a temporal separation of the states of each received single photon by time delaying the received single photon using frequency dispersion to time-bin the at least two states of each single photon in respective time-bins;
modulating 540 the at least two states of each single photon by individually modulating each time-bin associated with said time-binned states of the single photon, using a predetermined modulation scheme; and
detecting 550 each single photon and determining the time-bin said single photon was detected in.

In some examples modulating 540 each time-binned state of the single photon is performed actively and independently according to the predetermined modulation scheme.

In some examples the method further comprises determining the performed modulation of the detected state based on the determined time-bin said each photon was detected in. In some examples of the method 500, detecting 550 further comprises for each photon performing single-photon interference.

In some examples of the method 500, transmitting 510 further comprises for each photon transmitting each photon states to one of a plurality of receivers, and wherein receiving 520 the photonic output comprises receiving said states of said corresponding photon at said corresponding receivers. Dividing the each transmitted photon allows for one sender to provide several receivers with entangled photon pair states.

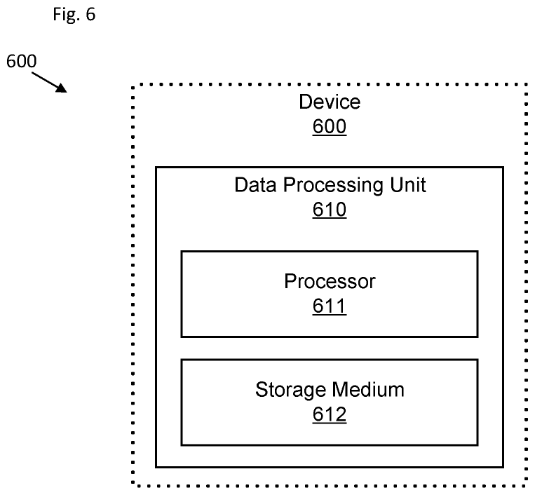

FIG. 6 depicts schematically depicts a data processing unit comprising a computer program product for performing the method for quantum communication. FIG. 5 depicts a data processing unit comprising a computer program product comprising a non transitory computer-readable storage medium 612. The non-transitory computer-readable storage medium 612 having thereon a computer program comprising program instructions. The computer program is loadable into a data processing unit 610 and is configured to cause a processor 611 to carry out the method for quantum communication in accordance with the description of FIG. 4 and/or FIG. 5.

The data processing unit 610 may be comprised in a device 600. In some examples, the device 600 is the computer and/or memory storage comprised in system for quantum communication described in FIG. 1a-c and/or FIG. 3.

The device 600 may be a computer and/or control circuitry.

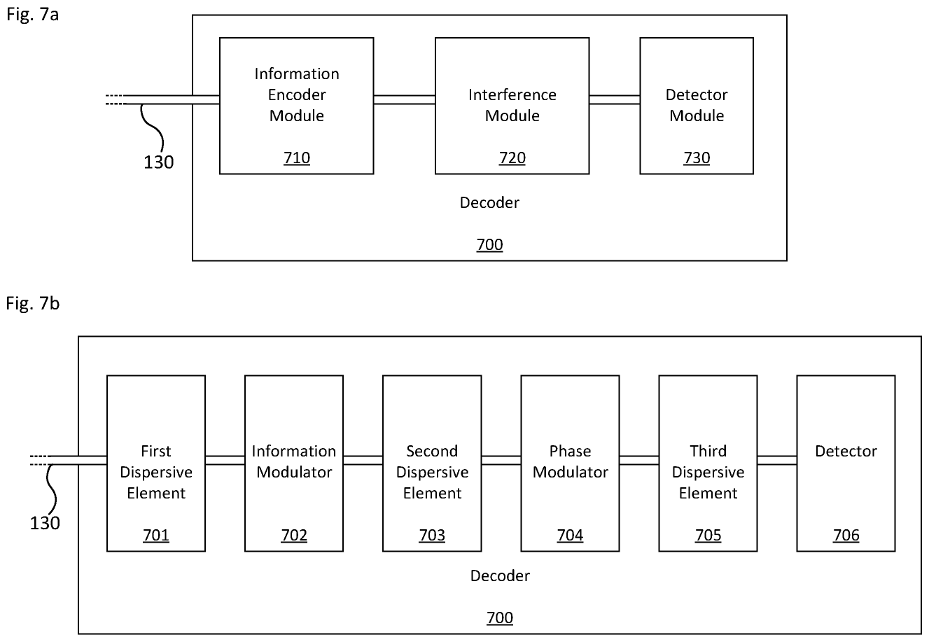

FIG. 7a-b illustrate an example decoder 700 utilizing interference between states in different frequency-bins. FIG. 7a shows the example decoder 700 in terms of functional modules in and FIG. 7b shows the example decoder 700 in terms of components.

In the frequency domain, phase modulations and frequency modulations are similar, therefore a phase modulation of a state may be viewed as creating different frequency paths. A plurality of states in different frequency-bins may, after phase modulation, contribute to parts of the same frequency path and interfere. The creation of these frequency paths is typically performed using phase modulators at their half-wave voltage Vπ, modulated at the frequency Q with signals of normalized amplitudes equal V/Vπ and definite phase. The superposition of such indistinguishable frequency paths originating from states with different frequency results in quantum interferences which may be calculated for each frequency path by performing summation and squaring the sum.

FIG. 7a illustrates an example decoder 700 represented as comprising an information encoder module 710, an interference module 720 and a detector module 730. The information encoder module 710 is arranged to receive photonic output comprising a d-dimensional frequency-binned single photon via a quantum channel 130 and modulate said single photon. The interference module 720 is arranged to provide a photonic output to the detector module 730 based interference between at least two phase modulated states of said received single photon. The detector module 730 is arranged to detect said single photon and determine the time-bin said single photon was detected in.

In a comparison with a typical Mach-Zehnder interferometer, the function of the information encoder module 710 may be compared with a modulator along one of two paths of a Mach-Zehnder interferometer, and the function of the interference module 720 may be compared with a beam-splitter arranged before the detector(s) where the two paths meet and interference may occur.

FIG. 7b shows the example decoder 700 comprising a first dispersive element 701, an information modulator 702, a second dispersive element 703, a phase modulator 704, a third dispersive element 705, and a photon detector 706. In this example the first, second and third dispersive elements 701,703,705 are positive, negative and positive dispersive elements respectively.

The decoder 700 is arranged to receive photonic output comprising a d-dimensional frequency-binned single photon via a quantum channel (130). In this example the states of the received single photon have substantially the same spatiotemporal propagation.

The first dispersive element 701 is arranged to time-bin the received single photon by time delaying the states of the received single photon based on frequency.

The information modulator 702 is arranged to modulate the time-binned states of the single photon by individually modulating each time-bin of said single photon.

The second dispersive element 703 is configured to time delay the time-binned plurality of states of the single photon such that said states have substantially the same spatiotemporal propagation.

The phase modulator 704 is configured to create interference between at least the states with different frequency of the frequency-binned single photon. In some examples the phase modulator 704 utilizes a modulation frequency that corresponds to the frequency distribution of the received d-dimensional frequency-binned single photons. It should be understood that a frequency distribution corresponding to frequency-binned received single photons is typically known before receiving said single photons.

The third dispersive element 705 is arranged to time-bin the phase modulated single photon by time delaying the modulated single photon based on frequency.

The photon detector 706 is arranged to detect the single photon and determine the time-bin it was detected in.

In this example the states of the received single photon entering the decoder 700 had substantially the same spatiotemporal propagation; thereafter the states were time-binned and information modulated; thereafter the states were gathered to have substantially the same spatiotemporal propagation, phase modulated causing interference between frequency-binned states; and thereafter the states were time-binned and the single photon was detected in a time-bin. In this example a part of the information modulation is performed randomly, such as randomly selecting a basis in a manner similar to a corresponding random bias selection in a encoder (not shown) preparing and transmitting said received single photon, whereas the phase modulation is performed according to a predetermined scheme.

In this example the first and second dispersive element 701,703 may be either a positive and a negative dispersive elements, or a negative and a positive dispersive elements. In these examples the third dispersive element 705 may be either a negative or a positive dispersive element.

The example decoder 700 in FIG. 7 may be comprised in a system for quantum communication with d-dimensional frequency-binned single photons as described in FIG. 1a-c. The example decoder 700 in FIG. 7 may be comprised in a system for quantum communication with d-dimensional frequency-binned entangled photon pairs as described in FIG. 3.

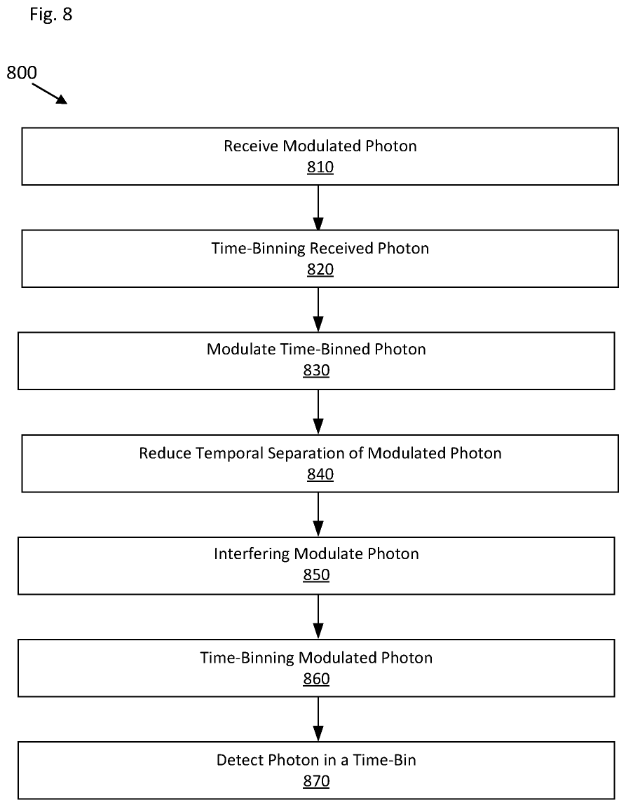

FIG. 8 shows a decoder method for single photon quantum communication utilizing interference, the method 800 comprising
receiving 810 a photonic output via a quantum channel, wherein said photonic output comprising a d-dimensional frequency-binned single photon in a superposition of at least two states with different frequencies;
time-binning 820 said states of the single photon by time delaying the received single photon using frequency dispersion to time-bin the at least two states of said single photon;
modulating 830 the time-binned at least two states of the single photon by individually modulating each time-bin associated with the time-binned states of the single photon, using a predetermined modulation scheme;
reducing 840 the temporal separation of time-binned states of the single photon introduced by time-binning 820 each single photon state based on frequency;
interfering 850 at least two frequency-binned states of the single photon utilizing phase modulation;
time-binning 860 said states of the single photon by time delaying the single photon using frequency dispersion to time-bin the at least two states of said single photon; and
detecting 870 the single photon and determining the time-bin said single photon was detected in.

In some examples interfering 850 at least two frequency-binned states of the single photon, comprises phase modulating said single photon thereafter interference occurs between said at least two frequency-binned states.

In some examples of the method 800, reducing 840 the temporal separation of time-binned states of the single photon comprises substantially reducing the temporal separation of time-binned states of the single photon to zero.

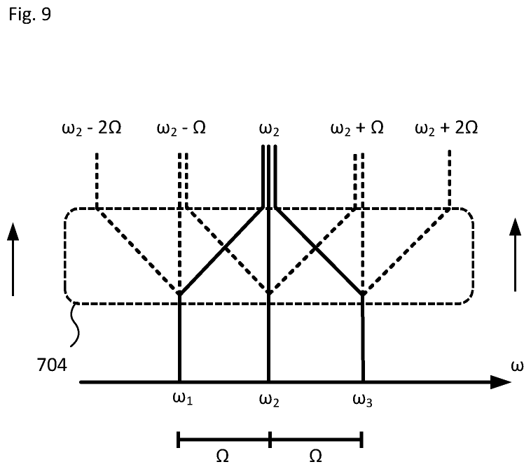

FIG. 9 illustrates phase modulation in the frequency domain for three frequency-binned states of a single photon. The illustrated example serves to help visualize how interference between different frequency-bins may be achieved, the example is simplified and may not correspond to real world conditions. The phase modulator 704 may be the same phase modulator 704 as in the description of FIG. 7.

This example shows three states of a single photon in the frequency domain having three different frequencies (ω₁, ω₂, ω₃), with a difference of Q between ω₁ and ω₂, and ω₂ and ω₃. In this example the three states travel through (upwards in FIG. 9) a phase modulator 704 grouped together whereby phase modulation creates for each state two frequency paths corresponding to said state's frequency plus/minus a modulation frequency. In this example the phase modulator 704 is configured to frequency modulate the states with ±Ω, the same value as the difference between the second frequency (ω₂) and the other states. It is to be understood that phase modulation typically creates more than two frequency paths, such as ±2Ω, and that any such additional frequency paths are omitted from the example for brevity.

In this example the photonic output of the phase modulator 704 comprises states in frequency paths corresponding to ω₂, ω₂±Ω, and ω₂±2Ω. The frequency path corresponding to ω₂ contains contributions from all three states (solid lines in FIG. 9) and said three states interfere for said frequency path.

In some examples a large number of frequency-binned states with equally spaced frequencies of a single photon are phase modulated thereby a majority of states interfere with a plurality of states. That is to say a minority of the frequency-bins are at the edges of their respective frequency-bin grouping.

The term photonic output relates to a light pulse of electromagnetic radiation. An example photonic output of a photon source is a pulse of one single photon. It is to be understood that the generation of a photonic output may be a stochastic process and therefore a photonic output during a duration may contain zero, one, two or more photons. Unless stated otherwise the described examples assume each photonic output is a pulse containing one single photon.

The term dispersive relates to a property of a media or an element, which property causes frequency dependent time delay of electromagnetic radiation. An example dispersive element is a dispersive prism with wavelength-dependent refractive index. A dispersive element may for example provide a time delay of a photon state based on frequency, such as time-binning temporally grouped photon states with different frequency. The term positive dispersion relates to positive group velocity dispersion for which time delay is longer for lower frequencies. The term negative dispersion relates to negative group velocity dispersion for which time delay is longer for lower frequencies. It is to be understood that a positive (negative) dispersive element may exhibit positive (negative) dispersion only in a part of the electromagnetic spectrum.

The term temporal separation of photon states relates to the spatiotemporal distribution of said states. Temporally separated photon states may be interpreted as photon states being sufficiently separated in time for the states to be individually modulated based on the period of time it moves through a modulator. In one example, a plurality of initially spatiotemporally grouped photon states with different frequencies may be temporally separated into time-bins by passing through a dispersive material. In a corresponding example, a photon with time-binned frequency states passing through a dispersive material may have its states become spatiotemporally grouped.

The term spatiotemporal propagation of photon states relates to positions and times at which states may be detected. Photon states with substantially the same spatiotemporal propagation are to be understood as states travelling through spacetime grouped together.

The term time-bins relate to a plurality of time-slots, each of which may be associated with an event or entity occurring or existing at some position in space. The time-bin of a photon state may represent a possible time of arrival at a modulator and/or a detector for said photon state. Time-binned photon states may be understood as photon states that are distinguishably separated in the time domain. In the context of multi-state single photons it is to be understood that the term time-binned single photon relates to a photon with time-binned states. For example, a single photon may have superimposed quantum states with different frequencies, each of which is associated with a respective time-bin after passing through a dispersive media. The frequency states of the single photon is then said to be time-binned, and the dispersive media is said to perform the act of time-binning the superimposed frequency states of the single photon.

The term frequency-binned photon states relates to a frequency distribution of photon states. The frequency-binning of states is represented by a distribution in the frequency domain, in a similar manner as the time-binning of states is represented by a distribution in the time domain. Frequency-binned photon states may be understood as photon states that are distinguishably separated in the frequency domain. For example, a single photon in a frequency comb state is frequency-binned with a plurality of states with distinguishably separated frequencies, where each frequency-bin corresponds to a tooth of the frequency comb.

The term d-dimensional frequency-binned single photon relates to a photon with a number of distinguishable frequency-binned states equal to d, i.e. to a photon with d superimposed quantum states with different frequencies. As an example, a frequency comb generator may be arranged to provide a photonic output comprising a high-dimensional frequency-binned single photon, such as a single photon with ten or more states that have distinguishably different frequencies. An example d-dimensional frequency-binned single photon may be a single photon in a superposition of ten states (i.e., d=10) with different frequencies. That two or more states have different frequencies herein means that the states are distinguishable or separable from one another based on their difference in frequency. High-dimensional here relates to three or more dimensions.

The term modulator relates to an active component able to change some property of a photon. The modulator may for example rotate the polarisation of the photon according to one of a set of polarizations. Correspondingly a modulator may change one or more states of a single photon. In the context of the present disclosure, a modulator may, for instance, be an electro optic modulator (EOM).

The term quantum channel relates to any communication channel able to transmit quantum information. Example quantum channels are waveguides, optical fibres or free-space.

The term single photon source relates to an electromagnetic radiation source arranged to provide a photonic output comprising one single photon. It is to be understood that the generation of a photonic output may be a stochastic process and therefore a single photon source output during a duration may contain zero, one, two or more photons.

The term quantum key distribution (QKD) relates to secure communication using a cryptographic protocol based on quantum mechanical laws. An example QKD technique is based on preparing a quantum state of a photon in a randomly selected base out of a plurality of predetermined bases at a sender with an encoder, and detecting a quantum state in randomly selected base out of the plurality of predetermined bases at a receiver with a decoder. A well known QKD scheme is BB84.

The term quantum random number generator (QRNG) relates to a random number generator that is based on quantum mechanical laws. In some examples a QRNG is based on photons travelling through 50/50 beam splitters.

It is to be understood that utilizing dispersive media to allow modulation of states that have been time-binned based on frequency may be used broadly in quantum enabled communication, such as for general quantum communication and quantum computers.

Quantum Communication is the art of transferring quantum states from one place to another. The general idea is that quantum states encode quantum information: hence quantum communication also implies transmission of quantum information and the distribution of quantum resources such as entanglement. A quantum network is the network that adopts a quantum communication system. It consists of many separate nodes, and quantum information is processed or stored in these nodes. It also enables the transmission of information in the form of qubits between physically separated quantum processors.

Many tasks in communications can be enhanced beyond classical imitations by using quantum resources. Such quantum technologies often rely on distributing strongly correlated data that cannot be reproduced with classical theory, for example it violates a Bell inequality. To violate a Bell inequality, the parties involved in the scheme must share an entangled quantum state on which they perform suitable local measurements returning outcomes that can be locally processed and communicated by classical means. Such entanglement-assisted schemes have been shown to be successful in a wide variety of information-processing tasks, including secret sharing for which additional security features are enabled, Byzantine Agreement for which a classically unsolvable task can be solved and reduction of communication complexity for which optimal classical techniques are outperformed.

A fundamental problem in fault-tolerant distributed computing is to achieve coordination between computer processes in spite of some processes randomly failing because of, e.g., crashing, transmission failure or distribution of incorrect information in the network. For example, such coordination applies to the problem of synchronising the clocks of individual processes in distributed networks, which is pivotal in many technologies including data transfer networks and telecommunication networks. A method to achieve synchronisation is to use multipartite entanglement and alternatively a sequential transfer and rotation of single quantum system.

In communication complexity problems, separated parties perform local computations and exchange information in order to accomplish a globally defined task, which is impossible to solve single-handedly. Here we consider the situation in which one would like to maximise the probability of successfully solving a task with a restricted amount of communication. Such studies aim to, for example, speed up a distributed computation by increasing the communication efficiency, or at optimising Very large-scale integration (VLSI) and data structures. Quantum protocols involving multipartite entangled states have been shown to be superior to classical protocols.

Quantum communication is essential for building a distributed quantum processor from interlinked quantum computers.

The invention relates to components in quantum information processors for a photonic quantum computer. The use of dispersive media facilitates the use of qudits encoded in d-frequency bins in quantum computing, for example, by providing frequency shifters, flip gates, Hadamard gates and CCNOT gates.

FIG. 10 schematically illustrates a single photon states passing through a frequency shifter 900. The example frequency shifter 900 comprises, in order, a frequency modulator 901, a dispersive element 902, and an amplitude modulator 903. The frequency modulator 901 is arranged to, upon receiving a photon state, for each received photon state output at least two photon states with different frequency. The dispersive element 902 is arranged to time delay photon states based on frequency utilizing dispersion, thereby time-binning the frequency-binned photon states received from the frequency modulator 901. The amplitude modulator 903 is arranged to modulate the frequency-binned and time-binned photon states received from the dispersive element 902 to output one frequency state. In some examples, the output of the amplitude modulator 903 is the output of the frequency shifter 900, and said output is connected to a quantum channel 130.

The illustrated example shows a single photon state entering the frequency modulator 901, for example from a photon source 111, visualized in the time-domain 210 and the frequency-domain 220 as it propagates through the frequency shifter 900 to a quantum channel 130. The representation of the photon state(s) in the time-domain 210 and the frequency-domain 220 serve the purpose to illustrate frequency-modulated states, temporally separated states and amplitude modulated states, and may not accurately depict an obtained experimental measurement.

The single photon state received by the frequency modulator 901 is in the time-domain 210 and the frequency-domain 220 represented by the time t₀ and the frequency ω₀. After passing through the frequency modulator 901 the photon state is now three states represented by the frequencies ω₀, ω₊, ω₋, all are temporally gathered as represented by the time t₀. In this example, ω₊ is a higher frequency than ω₀, and ω₋ is a lower frequency than ω₀. The three photon states output of the frequency modulator 901 may be considered frequency binned and temporally gathered, thereby resembling the input of the first dispersive element 112 in FIG. 2.

After passing through the dispersive element 902, the three photon states have been time delayed based on frequency, whereby the three states are temporally separated. In this example the states with three different frequencies are separated correspond to the times to, t₊, t₋, as represented in the corresponding time-domain 220. In this example, the state corresponding to t₊ and ω₊ exits the dispersive element 902 after the to-state, and the state corresponding to t₋ and ω₋ exits the dispersive element 902 before the to-state.

The now temporally separated photon states enter the amplitude modulator 903, wherein the amplitude modulator 903 is arranged to modulate states corresponding to different time and frequency bins. The amplitude modulator 903 is arranged to only allow the output to consist of states in specific frequency bins. In this example, the amplitude modulator 903 is arranged to output a state in one frequency bin, here the output state is represented by t₊ω₊ in the time and frequency domain. In some examples, the amplitude modulator 903 is arranged to output t₋ω₋. In some examples, the amplitude modulator 903 is arranged to output at least two states in different frequency bins, such as t₊ω₊ and t₋ω₋. It is to be understood that typically, the expression of only providing output in one or two different frequency bins relates to some minimum amplitude criteria for said states.

The dispersive element 902 in the frequency shifter 900 may be a dispersive element 112,114 according to the description of FIGS. 1 and 2.

In some examples, the frequency modulator 901 is arranged to, upon receiving one photon state as input, output at least three states with different frequencies. In some of these examples, the frequency modulator 901 is arranged to output at least five states with different frequencies.

In some examples, the amplitude modulator 903 is arranged to output one frequency state or two frequency states. In some examples, the amplitude modulator 903 is arranged to output frequency states, wherein each output frequency state is a different frequency than the frequency of the photon state received by the frequency shifter 900 and/or the frequency modulator 901.

In some example, the frequency shifter 900 comprises an second dispersive element (not shown) arranged to receive the output of the amplitude modulator 903, wherein the second dispersive element is arranged to time delay states based on frequency in an equal but with opposite relative time delays between frequencies as the first dispersive element 902 at least in some frequency range, such as the first dispersive element 902 being a negative dispersive element and the second dispersive element being a corresponding positive dispersive element. For example, the output of the amplitude modulator 903 in FIG. 10 is t₊ω₊ passing through the second dispersive element would result in an output of t₀ω₊, thus said example frequency shifter 900 comprising the second dispersive element provides, for at least some input photon states, an output that only is changed in frequency.

It is to be understood that the frequency shifter 900 may be arranged to receive a plurality of photon states as input. The example in FIG. 10 illustrates one photon state input for sake of legibility.

A flip gate comprising a frequency shifter 900 comprising, in order, a frequency modulator 901, the dispersive element 902, and an amplitude modulator 903, wherein the frequency shifter 900 is arranged to
receive a photon state at a first frequency,
split the photon state into a plurality of frequencies utilizing the frequency modulator 901,
time-bin said plurality of frequencies utilizing the dispersive element 902, and
amplitude modulate said time-binned plurality of frequencies to output one of said plurality of frequencies utilizing the amplitude modulator 903.

In some examples, the flip gate is arranged to
upon receiving an photon state of a first frequency, amplitude modulate the time-binned and frequency-binned photon states received by the amplitude modulator 903 to output one photon state in a frequency bin corresponding to a second frequency, and
upon receiving an photon state of the second frequency, amplitude modulate the time-binned and frequency-binned photon states received by the amplitude modulator 903 to output one photon state in a frequency bin corresponding to the first frequency.

For example, placing multiple such flip gates in series with an initial input of a photon state with the first or the second frequency results in the frequency alternating between the first and the second frequency.

A Hadamard gate comprising a frequency shifter 900 comprising, in order, a frequency modulator 901, the dispersive element 902, and an amplitude modulator 903, wherein the frequency shifter is arranged to
receive a photon state at a first frequency,
split the photon state into a plurality of frequencies utilizing the frequency modulator 901,
time-bin said plurality of frequencies utilizing the dispersive element 902, and
amplitude modulate said time-binned plurality of frequencies to output two of said plurality of frequencies utilizing the amplitude modulator 903.

A CCNOT gate, Toffoli gate, comprising two or more frequency shifters 900 comprising, in order, a frequency modulator 901, the dispersive element 902, and an amplitude modulator 903.

1. An encoder for quantum n communication, the encoder comprising a first dispersive element and an encoder modulator, wherein the first dispersive element is arranged to obtain photonic output and is configured to time delay states of a d-dimensional frequency-binned single photon comprised in said photonic output based on frequency, thereby time-binning the states of said single photon, and
wherein the encoder modulator is arranged to modulate time-binned states of the single photon by modulating individual time-bins of said single photon, using a predetermined modulation scheme.

2. The encoder according to claim 1, further comprising a second dispersive element arranged after the encoder modulator, and configured to time delay the states of said single photon based on frequency to reduce a temporal separation of the states of said single photon.

3. The encoder according to claim 2, wherein the second dispersive element is configured to time delay the modulated states of the single photon such that modulated time-binned states of the single photon have substantially the same spatiotemporal propagation after interaction with the second dispersive element.

4. The encoder according to claim 1, further comprising a photon source arranged to provide the photonic output comprising the d-dimensional frequency-binned single photon.

5. The encoder according to claim 1, comprising a frequency shifter comprising a frequency modulator connected to a dispersive element connected to an amplitude modulator,
wherein the frequency modulator is arranged to upon receiving a photon state output at least two photon states with different frequency, wherein the dispersive element is arranged to time delay photon states based on frequency utilizing dispersion, and wherein the amplitude modulator is arranged to modulate the frequency-binned and time-binned photon states received from the dispersive element to output one frequency state and/or to output two frequency states.

6. A decoder for quantum communication, the decoder comprising a decoder dispersive element, a decoder modulator, and a photon detector,
wherein the decoder is arranged to receive photonic output comprising a d-dimensional frequency-binned single photon via a quantum channel,
wherein the decoder dispersive element is arranged to time-bin states of the received single photon by time delaying the states of the received single photon based on frequency,
wherein the decoder modulator is arranged to modulate time-binned states of the single photon by modulating individual time-bins of said single photon using a predetermined modulation scheme, and
wherein the photon detector is arranged to detect the single photon and determine the time-bin it was detected in.

7. A system for single photon quantum communication, the system comprising the encoder according to claim 2 a decoder comprising a decoder dispersive element, a decoder modulator, and a photon detector, wherein the decoder is arranged to receive photonic output comprising a d-dimensional frequency-binned single photon via a quantum channel, wherein the decoder dispersive element is arranged to time-bin states of the received single photon by time delaying the states of the received single photon based on frequency, wherein the decoder modulator is arranged to modulate time-binned states of the single photon by modulating individual time-bins of said single photon using a predetermined modulation scheme, and wherein the photon detector is arranged to detect the single photon and determine the time-bin it was detected in;
wherein the encoder and the decoder are arranged to communicate with d-dimensional frequency-binned single photons via the quantum communication channel, and
wherein the decoder modulator and the encoder modulator are arranged to modulate the states of the single photon utilizing the same predetermined modulation scheme.

8. A system for entangled photon pair quantum communication, the system comprising an entangled photon pair source, and two decoders according to claim 6,
wherein the entangled photon pair source is arranged to transmit to each decoder via a respective quantum channel photonic output comprising one photon of one pair of entangled photons, wherein said entangled photons are a d-dimensional frequency-bin entangled photon pair, and
wherein the decoder modulator of each decoder is configured to modulate the states of the received photon utilizing the same predetermined modulation scheme.

9. A method for single photon quantum communication, the method comprising
obtaining a photonic output from a photon source, the photonic output comprising a d-dimensional frequency-binned single photon in a superposition of states with different frequencies;
time-binning the states of the single photon by time-delaying the states of the single photon using a first frequency dispersion;
modulating the time-binned states of the single photon by modulating individual time-bins of said single photon, using a predetermined modulation scheme; and
transmitting the modulated single photon via a quantum channel.

10. The method according to claim 9, further comprising
reducing a temporal separation of the modulated states of the single photon, after modulating the states of the photon and before transmitting the single photon, by time delaying the states of the single photon using a second frequency dispersion, wherein the second frequency dispersion corresponds to an inverse group velocity dispersion of the first frequency dispersion.

11. The method according to claim 9, further comprising
receiving the transmitted single photon via the quantum channel;
modulating the states of the received single photon by modulating individual time-bins of said single photon, using the predetermined modulation scheme; and
detecting the single photon and determining the time-bin the single photon was detected in.

12. The method according to claim 11, further comprising
time-binning states of the received single photon, after receiving the single photon and before modulating the states of the single photon, by time delaying the states of the received single photon using a first receiver frequency dispersion.

13. The method of claim 12, wherein the first receiver frequency dispersion substantially counteracts the second and inversed frequency dispersion such that the temporal separation of the time-binned states of the single photon during modulation substantially corresponds to the temporal separation of the time-binned states of the single photon during the modulation performed before transmission.

14. A method for single photon quantum communication, the method comprising
receiving a photonic output via a quantum channel, wherein said photonic output comprises a d-dimensional frequency-binned single photon in a superposition of states with different frequencies;
time-binning the received single photon by time delaying the states of said single photon using a first receiver frequency dispersion;
modulating the states of the single photon by modulating individual time-bins of said single photon, using a predetermined modulation scheme; and
detecting the single photon and determining the time-bin the single photon was detected in.

15. A method for entangled photon pair quantum communication, the method comprises
transmitting two photonic outputs, each via a respective quantum channel, wherein each photonic output comprises one photon of one pair of entangled photons, wherein said entangled photons are a d-dimensional frequency-bin entangled photon pair, and wherein each photon is in a superposition of states with different frequencies;
receiving, in two decoders, one photon each of the pair of entangled photons, and, in each of the decoders:
time-binning the states of the received photon using frequency dispersion to time-bin the states of the received photon;
modulating the time-binned states of the photon by modulating individual time-bins of said photon, using a predetermined modulation scheme; and
detecting the photon and determining the time-bin said photon was detected in.

16. A computer program product comprising a non-transitory computer-readable storage medium having thereon a computer program comprising program instructions, the computer program being loadable into a processor and configured to cause the processor to perform the methods for single photon quantum communication according to claim 9.
